(19) United States
(12) Patent Application Publication
(10) Pub. No.: US 2010/0314138 A1
(43) Pub. Date: Dec. 16, 2010

(54) Humidity modifier system

(76) Inventor: Gary Weatherspoon, Mitchelville, MD (US)

Correspondence Address: Gary Weathrspoon, 12138 Central Avenue, Suite 520, Mitchellville, MD, 20721, US

(21) Appl. No.: 12/081,266

(22) Filed: Apr. 14, 2008

(51) Int. Cl. A62C 35/68

(52) U.S. Cl. 169/16

(57) ABSTRACT

The Humidity Modifier System is water dispensing fire suppression network of aerosol spray nozzles and piping support apparatus for an in ground and structure attachment application. The system water supply can be independently stored, swimming pool or retrofitted to the property utilities. The water pumps used to pressurize the water in the line of the system are powered by an independent generator or gasoline. When the Humidity Modifier System is on and charged the nozzles' aerosol distribution produce a barrier of continuously suspended droplets. The densely concentrated mist makes the area less conducive to fires. The approach of modifying surrounding air to suppress the fire is the new direction. The Humidity Modifier System technique is adaptable to any environment, easy to install, and affordable. The Humidity Modifier can be made cookie cutter to fit any structure or area. My system is environmental safe.

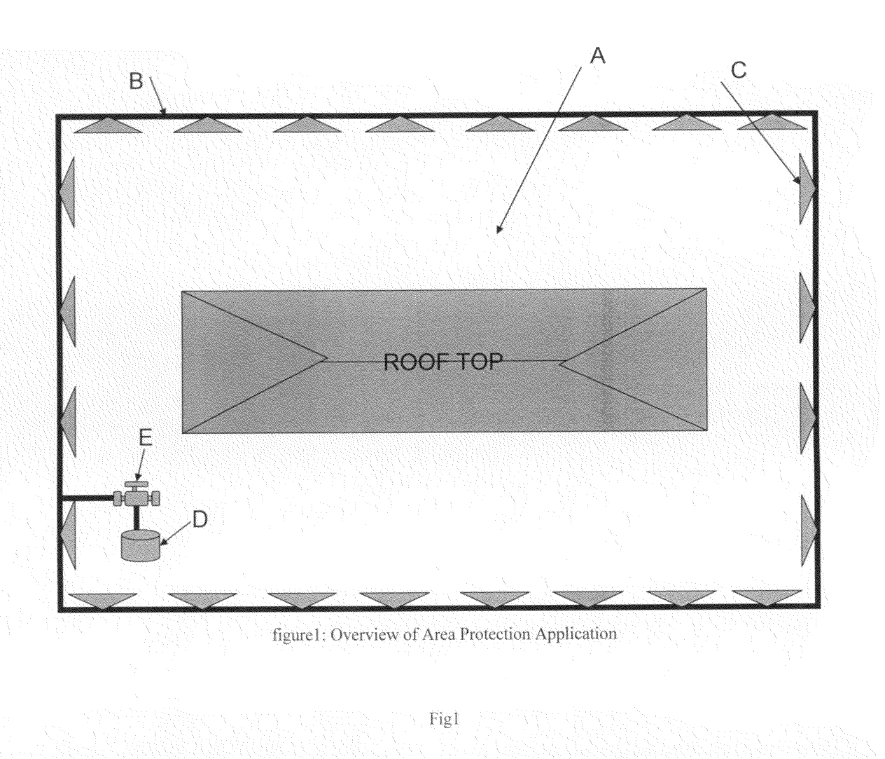

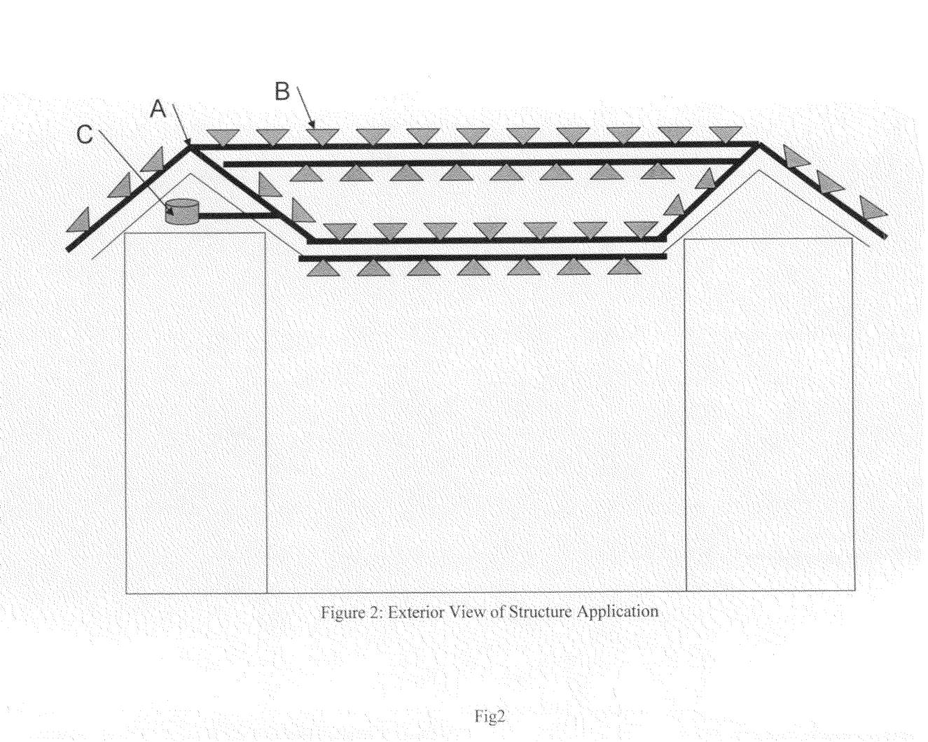

The Humidity Modifier System is a system made of piping with heat resistant cpvc, flat headed aerosol nozzles, check valves, and water pump with electrical or gasoline power source to maintain water pressure in the lines. The system uses water pressure to produce fine mist from the nozzles heads. The heat resistant 1¼-2 inches piping is buried underground with cap covers and pop-up risers to protect the nozzles from ground traffic. Similar, to our sprinkler or irrigation system used in farming and gardening. However, this system is place around the parameter of building and populated areas for fire suppression. When the system is turned on the nozzles pop up to the ground surface. The nozzles are flat head with opening ¼ to ⅛ mm orifices, placed inline separated 5′ feet apart. The piping and nozzle heads formation completely surrounds the parameter of the structure or area to be covered. The water source can be water stored in an independent storage, swimming pool, nearby reservoir or utilities. The distribution from each nozzle produces a high concentration of aerosol under water pressure. By droplets colliding with neighboring nozzles droplet production, the surrounding air becomes completely saturated with fine mist. This is the Humidity Modifier System of fire suppression. My system changes the moisture in the air and with continuous use the moisture begins to deposit on everything, reducing the fire's fuel, stopping the spread.

The Humidity Modifier System can be made in any formation to match the area or structure to be protected. The concept of humidity modification is the new approach to fire fighting. My system directs it effects on changing the amount of moisture in the air of immediate area. It uses fine mist (very light aerosolized water to increase humidity) to add to absolute moisture partial pressure of atmospherics' pressure total. Dalton's law of partial pressures states that the pressure of a mixture of gases simply is the sum of the partial pressure of the individual components. (Wikipedia) Changing the atmospheric moisture in the immediate area, in turn deceases fire production and spreading of ambers. My system eliminates the problems associate with fighting brush fires and wildfires in remote and drought stricken places. The Humidity Modifier System requires a fraction of the water used in conventional methods. The system produces fine mist aerosol, so water sources last longer; the aerosol has proven to be more effective on direct fire. The fine mist water heats up turning into stream; the freed hydrogen molecule competes with the fire for oxygen. This smothers the fire. My fine mist well travels in the wind (Santa Anna's winds) along with any ambers of a wildfire. This eliminates the spread of ambers during wildfires in drought areas.

The strategic incorporation of the Humidity Modifier System is a passive, but highly effective tool for fire fighting. The approach of increasing the moisture available in the air decreases the drought condition in the protected area. My concept allows objects and plant life to absorb moisture making it less likely to burn. The Humidity Modifier System and conventional fire safety will reduce or eliminate the devastation caused by brush and wildfire.

Detail specification of my drawings show the Humidity Modifier System's application for structure, and area protection. 1 Fig. shows the system attached to the structure. The system is installed to extent the length of the roof. It runs parallel to the shape of the roof line. The humidity modifier system is made of 1-1¼ inch 40 gauge cpvc or heat resistant material piping. Cpvc t-shape adapters are cement glued inline every 3′-5′ feet apart with an extension and capped with a nozzle. My flat head stainless steel aerosol nozzles are pre-tapped and pre-cemented inline at a 45* degree angle aimed at the protected area. The nozzles each have a ⅛ mm output orifice with a spray angle of 110* degree with up to 0.6 gpm output volume of mist at 60 psi water pressure. The water source to the system can be retrofit tap into the existing structure's utilities, swimming pool or stored independently. The water pump is inline down line of the water source outlet. The drawing in 1 Fig. shows the water source attached up line in the system. The water pump is stored in the hollow space in the attic. The power source to the water pump runs by electric from the structure or independent generator.

3 Fig. shows the area protection application of the Humidity Modifier System. The system is buried in ground bordering the coverage area. This application requires large 2 inch piping cpvc or heated resistant material to supply the nozzles with water. Flat head stainless steel aerosol nozzles are glued inline 5′ feet apart, pre-tapped and pre-cemented at 45* degree angle into capped T-shape adapters. The nozzles each have a ¼ mm output orifice with 110* degree spray and 0.9 gpm output volume at 80-100 psi water pressure. The direction nozzles spray angles cause the droplets to collide creating a high concentration of mist. This unique form of mist develops a barrier from all fires. The constant use of my system extinguishes and inhibits fire in any environment. Modifying of the surrounding humidity is my core principle of my invention and new technology of fighting and preventing fires.

What is claimed is:

1. An in ground aerosol dispensing nozzle system installation comprising a pop-up flat head nozzles housed within an in ground riser with cap covers. First, place a stake or flag at every nozzles location, and then use string to show where the pipe will run.
1. The PVC or poly piping labeled as B is installed underground 6-12 inch around the parameter of the area to be covered. Use a trench digger. Lay the piping. The piping formation creates the frame encompassing the protection area. The unobstructed pathway supplies water to nozzles of claim 2 surrounding the property.
A. The PVC or poly piping labeled as B of claim 1 is made of heat resistant material. The connections are made with PVC or poly piping T-shape and elbow adapters glued in placed using clement glue used in plumbing.
B. The piping labeled as B of claim 1 is connected to a water source outlet, which—in turn feeds water to the inlet of the water pump label E in the system. The 2″ inch outlet hose from water pump feeds the piping supplying the nozzles.
2. The nozzles labeled as C of claim 2 are stainless steel flat head tipped with ⅛ mm output orifice and spray angle 110* degree are placed 5′ feet apart in the system. The piping is cut; then T-adapter and nozzle assemblies are glued in place of the system.
A. The nozzles labeled as C of claim 2 are placed on a 45* degree angle in the direction of the protected area and perpendicular to the spray angle of the opposite nozzle position.
B. The nozzles labeled as C of claim 2 produce macro droplets in large volume when charged.
3. The water pump label as E receives water supply, then pressurize the system. The water pump is capable of 600 g.p.h. flow rates or 100 psi water pressure in the system.
A. Water pump of claim 3 is hydro-blaster used in swimming pool drainage. However, the pump produces enough pressure to force water thought the nozzles at a high rate when the system is on.
B. Water pump of claim 3 used in my illustration is gasoline operated, but the water pump can electric or retrofitted to existence utility.
4. Water source is stored for use in my aerosol dispensing fire suppression system.
A. Water stored labeled as D shows container adequate enough to supply up 2 hours.
B. Water source can be retrofitted form existent utility, independent of structure or siphon from swimming pool.
An aerosol dispensing system installation comprised of an integrated network of nozzles lining the edge of the roof line with 40 gauge sprinkler piping and nozzles placed 3-4 ft apart. Using string and nails outline the placement for the piping on the roof edge. First, place a small nail at each corner of the roof, and then run string to show the piping formation.
5. The PVC or poly piping labeled as A is installed on the roof of the structure around the edge of the roof line. Use C-claps to secure the system to the roof.
A. This form the skeleton of the roof application. The nozzles labeled as B are placed 3-4 ft apart inline with T-adapters
6. The nozzles labeled as B are ¼ mm output orifice stainless steel fine mist aerosol flat head with 110* degree angle spray. Each nozzle is directed to spray in the direction of the nozzles opposite of its location.
7. The water compressor labeled C is used to produce water pressure in the line.
8. The water source can be independent or connected to the structure utilities.
